(19) United States
(12) Patent Application Publication
(10) Pub. No.: US 2025/0313730 A1
(43) Pub. Date: Oct. 9, 2025

(54) All-natural, reactivatable, and reversible adhesive

(71) Applicant: Robert Sheets, Ames, IA (US)

(72) Inventor: Robert Sheets, Ames, IA (US)

(21) Appl. No.: 18/629,660

(22) Filed: Apr. 8, 2024

(51) Int. Cl. C09J 11/06; B32B 37/12; C09J 5/06; C09J 189/00

(52) U.S. Cl. CPC C09J 11/06; B32B 37/12; C09J 5/06; C09J 189/00; B32B 2317/16; B32B 2317/18

(57) ABSTRACT

The invention is a series of all-natural, heat-reactivating, reversible adhesives which can be used to produce mono-material film packaging and wood products of improved recyclability. The adhesive is composed of betaine, collagen peptides, and a monosaccharide along with other modifiers and fillers, such as gelatin and whey protein. This adhesive is dissolved in the fast-drying all-natural solvent ethanol and can be modified for other evaporable solvent systems.

### BACKGROUND OF THE INVENTION

This invention relates to a novel series of adhesives. Specifically, this invention relates to a series of heat-reactivating adhesives which have desirable evaporable solvent choices, are all-natural, and reversible. For the purposes of this disclosure, all-natural refers to being solely comprised of biological material in the invention's unadulterated form. These desirable evaporable solvents include, but are not limited to water, methanol, and ethanol. These options provide flexibility for the end user to balance toxicity versus drying speeds in the invention's intended use. Heat-reactivating refers to the dried invention regaining the ability to adhere to a new surface upon the addition of heat. Reversible refers to the ability to remove the adhesive following its intended lifetime with straightforward methods.

Adhesives are substances usually applied as liquids or gels which fix two surfaces together following the solidification of the original substance. The solidification of an adhesive can be due to solvent evaporation, temperature reduction, chemical reactions, or a combination thereof. Adhesives have an extensive history for use of cellulosic materials. Early inventions included caskets, weapons, and laminated wood.

Humankind has an extensive history of using natural adhesives which were often, but not always, polymeric. Such adhesives include birch tar, plant gums, casein, collagen, albumin, keratin, beeswax, carbohydrates, and latex. With the modern era, synthetic polymers, often derived from petroleum, have been introduced. This introduction of synthetic polymers vastly expanded the repertoire of substances which has allowed industries to fine-tune their formulations for specific needs. Synthetic adhesives include, but are not limited to, polyvinyl acetate, ethylene-vinyl acetate, acrylates, urethanes, epoxies, and cyanoacrylates. Other synthetic polymers, such as polyethylene, polypropylene, and polystyrene have been introduced to create countless structures and films for industrial and personal use as their plasticity facilitates molding into a desired shape. This introduction of synthetic polymers as both adhesives and structures comes at the expense of introducing potentially non-biodegradable substances into the environment.

The persistence of aforementioned synthetic substances in the environment has potentially hazardous consequences on human and environmental health. To alleviate this, incineration and recycling of these synthetic polymers have been encouraged. Incineration in waste-to-energy plants can be seen as wasteful, may release toxic fumes into the environment, and contributes to the petroleum-derived greenhouse gases. The alternative, recycling of these synthetic polymers, is potentially complicated as either the consumer or the recycling facility must separate plastics according to compatibility. Multi-layer film packaging is particularly difficult as incompatible layers are often laminated together to fulfil different functions for the final product. Recycling requires separation of said layers which is often difficult with non-reversible adhesives.

Given these complexities, there is a growing need to switch from multi-layer films towards so-called mono-material composite films. These mono-material composite films consist of at least two layers of singular type of plastic which comprises the bulk material. Often included are highly functional layers which replace the functionality demonstrated with multi-layer films. The functional layers within the mono-material must be negligible in mass or easily removable to not contaminate the resulting recycled material. These thin functional layers can include, but are not limited to, oxygen barriers and inks.

Packaging does more than just protect the product. It also serves the function of brand recognition and customer satisfaction through the introduction of inks. Inks complicate the recycling process as they create off-colors in recycled material. These aesthetic inconsistencies limit recycled plastics' options. Easy removal of inks in a water bath would be a valuable characteristic for preserving said aesthetics. Particularly for food applications, inks are normally laminated in an inner layer for both multi-layer and mono-material composite films. Removal of these inks to preserve aesthetics in the recycled material would first require separation of these layers prior to or during a washing step. Separation of said layers is often difficult with non-reversible adhesives. Given the complex logistics of recycling synthetic polymers to reduce environmental impacts, there is a need for an eco-friendly solution which simplifies the separation process for film packaging.

Fulfilling the need for said eco-friendly solution necessitates a novel series of adhesives with desirable characteristics to be further disclosed in the specification.

### BRIEF SUMMARY OF THE INVENTION

The invention is a series of all-natural heat-reactivating reversible adhesives comprising betaine, collagen peptides, and at least one monosaccharide as the primary components dissolved into an evaporable solvent, such as the fast-drying natural solvent ethanol. All-natural components have intrinsic benefits over synthetic components due to their relatively petroleum-independent synthesis and ease of biodegradation due to preexisting catabolic pathways in the biosphere. Heat-reactivation is a beneficial characteristic for adhesives as it allows components of a final product to be modularly manipulated prior to final assembly. Reversibility with water is desirable as it permits the easy disassembly of the aforementioned modular components. This disassembly may improve the reusability and recyclability of plastics and cellulosic materials.

Betaine is a nontoxic osmoprotectant and osmolyte isolated predominately from beets. It is naturally produced in the body. It may also be used as a supplement where it influences one-carbon metabolism by serving as a methyl donor to aid S-adenosylmethionine:S-adenosylhomocysteine ratios. Since it is generally recognized as safe (GRAS), it is an attractive adhesive component for materials which may come into contact with the environment or humans. It is very soluble in water and methanol but has limited solubility in ethanol.

Collagen is the most abundant protein in mammals as it is the primary component of connective tissue. The components which make up collagen are long peptide chains which are significantly modified, such as through glycosylation and hydroxylation. Three of these modified peptides can interact to form a triple helix. These helices are processed and crosslinked to create large molecules of approximately 300 kilodaltons. Gelatin can be extracted from collagen-rich tissues and can have average molecular weights within the range of 20 to 100 kilodaltons. The molecular weight is associated with gelatin's gel strength to resist depression, also known as its Bloom number. Partial hydrolysis of collagen results in collagen peptides which have masses between 1 and 30 kilodaltons. These collagen peptides have significantly less gelling capabilities than the larger-massed gelatin has. Since collagen, gelatin, and collagen peptides are generally recognized as safe (GRAS), they are an attractive adhesive component for materials which may come into contact with the environment or humans. They are soluble or swellable in water but are normally poorly soluble in alcoholic solvents. Due to heterogeneity of partially hydrolyzed products, some components of collagen peptides may be soluble in alcohol, but not necessarily in high concentrations.

Monosaccharides are colloquially referred to as simple sugars which, for the purposes of this disclosure, primarily refer to hexoses (containing 6-carbon) and pentoses (containing 5-carbon). Monosaccharides are a linear carbon chain which has multiple alcohol groups and a carbonyl group with the general chemical formula of Cₙ(H₂O)ₙ. This carbonyl group is located in the ultimate position of the carbon chain as an aldehyde in aldoses, or in the penultimate position of the carbon chain as a ketone in 2-ketoses. The carbon of this carbonyl is also known as the anomeric carbon. This carbonyl group is often reacted intramolecularly with one of the alcohol groups to cyclize the monosaccharide into either a furanose (5-membered ring) or a pyranose (6-membered ring) structure. This transforms the carbonyl into a hemi-acetal group for aldoses, or into a hemi-ketal for ketoses. Given the abundance of functional groups on a singular monosaccharide, there are many derivatives of monosaccharides. For instance, the hemi-acetals and hemi-ketals may form glycosides through a dehydration reaction. The alcohol groups may be replaced with hydrogen to result in deoxy sugars, such as deoxyribose in DNA. Alcohol functional groups may also be converted into alkyl ethers or esters. Although the present invention focuses on unmodified monosaccharides, it does not exclude the potential of chemically similar monosaccharide derivatives to fulfil the same role. Examples of monosaccharides include, but are not limited to, glucose, fructose, mannose, galactose, allulose, ribose, and xylose. Unmodified monosaccharides are generally very soluble in water with limited to no solubility in alcohols.

Individually, the primary components, betaine, collagen peptides, and monosaccharides are soluble in water. They have lower solubility in the alcohol solvent methanol and even lower in ethanol. With ethanol as the evaporable solvent, the addition of both betaine and a monosaccharide, such as mannose, fructose, ribose, and allulose, synergistically facilitates the mutual dissolution of both components. They stabilize each other in the otherwise impotent solvent. Ethanol can be evaporated from this solution to leave behind a viscous, clear liquid indicating a wide miscibility window between ethanol and the combination of the other components. Some combinations of betaine and a monosaccharide, such as glucose, have been reported to form a natural deep eutectic solvent (NADES) which suggests strong intermolecular hydrogen bonding between betaine and that specific monosaccharide. This modified solvent system is distinct from a NADES in that the desired dissolution properties are demonstrated while the individual components are still a minority (30% w/v) of the total solvent system. A hydrophilic NADES is also not necessarily compatible with ethanol which may disrupt the intermolecular hydrogen bonding and crash out the components.

Betaine and mannose, a monosaccharide, percentages greater than approximately 15% w/v individually introduced into ethanol modifies the solvent's properties such that it can readily dissolve collagen peptides with heating to approximately 80° C. or 176° F. Collagen peptides are not readily soluble concentration-wise in the alcohol solvents methanol nor ethanol normally. When the solution of betaine, mannose, and collagen peptides dissolved in ethanol is allowed to evaporate, it leaves behind a tacky film coating which adheres well to diverse substrates, such as, but not limited to, wood, paper, polyolefins, polystyrene, polyvinylidene chloride, aluminum foil, and glass. This film coating can serve as an adhesive.

The modified solvent system of betaine and mannose within ethanol is not generally capable of dissolving gelatin without the synergistic introduction of collagen peptides. The introduction of collagen peptides greater than 10% w/v permits dissolution of small amounts of gelatin of less than approximately 0.5% w/v. Gelatin has a history of being used as an adhesive known as hide glue. However, its use as an adhesive is greatly limited to aqueous, slow-drying, or potentially toxic solvents, such as acetic acid, glycerol, glycols, and formamide. Therefore, the stabilizing of gelatin into a fast-drying solvent such as ethanol provides novelty and extended utility.

The introduction of gelatin increases the viscosity of the solution, reduces the tackiness of the final film coating, and provides a stronger bond to surfaces. Higher introductions of gelatin results in gelation of the solution which can be temporarily liquefied with heating. Other components can be added to futher modify the properties of the resulting film coating which include, but are not limited to whey protein, cellulose particles, diatomaceous earth, clay particles, monosaccharide derivatives, disaccharides and their derivatives, oligosaccharides and their derivatives, and other natural substances. Synthetic substances may also be added without deviating from the spirit and scope of the described invention. Whey protein is of particular use as it greatly lowers the tackiness and is an all-natural byproduct of the cheese industry.

A particular embodiment of this adhesive composition in ethanol, which is comprised of 17% w/v betaine, 17% w/v collagen peptides, 17% w/v mannose, 1.7% w/v whey protein, and 0.17% w/v gelatin, can be applied onto various surfaces and can reactivate upon heating to approximately 80° C. or 176° F. This composition exclusively utilizes all-natural materials, dries clear in thin film coatings, is flexible, can be reformualted into aqueous and methanolic solvents, and is reversible with water. These properties are highly sought after as they can facilitate recyclability of films and cellulosic products in a non-toxic manner and improve biodegradability of their final products.

### DETAILED DESCRIPTION

The invention is prepared by placing the desired amounts of betaine, at least one monosaccharide or a monosaccharide derivative, and collagen peptides into a vessel, such as a glass jar. The vessel is filled with the chosen evaporable solvent to the appropriate level. The use of ethanol is a particularly desirable embodiment as it can be produced naturally and is fast-drying. The final concentrations for each component range between 10 and 40% w/v for an ethanol solution but can vary when dissolved in a different solvent. This mixture is heated to approximately the boiling point of the evaporable solvent to expedite the dissolution process. This takes approximately 5 minutes to dissolve with mixing or agitation. A composition in which all components are dissolved may be referred to as a solution. In alcohol solvents, the betaine and the monosaccharide synergistically facilitate the mutual dissolution of each other to be greater than that of the individual components. Regardless of the choice of evaporable solvent, this embodiment is referred to as the modified solvent system.

The combination of sufficient betaine and the monosaccharide(s) permits the dissolution of collagen peptides which is otherwise poorly soluble in ethanol. This capability to dissolve collagen peptides is maintained as the ethanol evaporates out of the modified solvent system leaving behind what may be considered a natural deep eutectic solvent (NADES)-plasticized collagen peptide residue. If the residue is coated on a surface to produce a film coating, it is generally clear, tacky, reversible with water, and can serve as an adhesive. If the residue is in the form of a mass, it may be used as a hot melt adhesive (HMA).

This modified solvent system is capable of dissolving collagen peptides when both betaine and the monosaccharides are individually at concentrations greater than approximately 15% w/v. When this modified solvent system includes sufficient collagen peptides of greater than 10% w/v, it is referred to as the quorum solvent (Q-sol) system as the individual components must be in sufficient quantities to successfully stabilize other proteinaceous compounds, such as gelatin and whey protein, into ethanol. Since the standard embodiment of the invention comprises betaine, collagen peptides, and mannose at 17% w/v individually, the standard Q-sol system comprises solid components totaling a quorum of 51% w/v.

Following the production of the Q-sol system, gelatin is also introduced into the vessel such that the final concentration is approximated 0.17% w/v but can range depending on the desired viscosity of the final product. Lower concentrations are generally used as viscosity rapidly increases with higher concentrations resulting in gelation. An embodiment of this invention as a gel may also have functionality as a hot melt adhesive. Gelatin dissolution is facilitated by adding as a hydrated gel of 8.5% w/v gelatin which readily dissolves to the target 0.17% w/v with heating near 80° C. or 176° F. Dehydrated gelatin may be added, but dissolution may be incomplete necessitating filtration of the residual solids. Gelatin is notably insoluble in ethanol without the synergistic combination of betaine, collagen, and mannose in sufficient concentrations provided by the Q-sol system.

The invention containing betaine, collagen peptides, mannose, and gelatin is translucent with brown coloration. Gelatin remains dissolved in the Q-sol system as the ethanol evaporates until a clear film coating is formed. This film coating has enough structure to adhere surfaces together, is reversible with water, and is reactivatable with mild heating at 80° C. or 176° F. There is still some humidity-dependent tackiness. If the Q-sol system is evaporated into a mass, it may serve as a hot melt adhesive.

Other components may be added to the vessel at the same stage as the gelatin to serve as modifiers and fillers. Natural components include, but are not limited to whey protein, cellulose particles, diatomaceous earth, clay particles, monosaccharide derivatives, disaccharides and their derivatives, oligosaccharides and their derivatives, and mineral carbonates. Synthetic components may also be added despite the goal of an all-natural adhesive, while still not deviating from the scope of the disclosure. Modifiers and fillers may not preserve translucency but may still be referred to as a composition which does not deviate from the spirit and scope of this disclosure.

Although the components are stabilized in ethanol within a specific embodiment of the invention, they are also compatible in a variety of other solvents. Alternative solvents include but are not limited to water, methanol. Although there is significant novelty in the dissolution of these components into a relatively nontoxic and fast-drying solvent, such as ethanol, it does not exclude the possibility of either transferring these components into or diluting with other solvents. This can be accomplished without deviating from the spirit and scope of this disclosure. If the evaporable solvent is removed from the bulk material prior to coating a surface, it may be used as a hot melt adhesive.

An embodiment of this adhesive composition which is opaque but dries clear with little tack consists of 17% w/v betaine, 17% w/v collagen peptides, 17% w/v mannose, 1.7% w/v whey protein, and 0.17% w/v gelatin in ethanol. This composition may be applied onto various substrates which include, but are not limited to wood, paper, polyolefins, polystyrene, polyvinylidene chloride, aluminum foil, and glass. This composition starts opaque as not all whey protein dissolves, but still dries as a clear film coating.

As an all-natural, reactivatable, and reversible adhesive, practicality for this invention is intrinsically as diverse as examples given in the background of this disclosure. Two notable examples include woodworking and packaging film production. For the purposes of fixing wood together, such as veneer onto a cheaper base material: the adhesive may be applied with a paint roller, squeegee, or spray nozzle onto one or both surfaces intended to be fixed together. Thicker applications can take longer to dry, but a waiting period of 24 hours is usually sufficient. Once the surfaces are placed together, a tacking iron can be used to reactivate the adhesive and fix the two surfaces together. Sensitive objects may not be compatible with heat but can still be adhered together by coating both surfaces and applying pressure until the two adhesive film coatings fuse together. This reversibility can permit the repositioning and reuse of often costly veneer. For porous materials which can permit the evaporable solvent to escape after application, the adhesive can be set through evaporation.

For the purposes of creating plastic film or cellulosic packaging, the adhesive may be applied through methods which include, but are not limited to, gravure, bar coating, spraying, brushing, slot die applying, bead/line applying, and roll coating. The coated materials can then be adhered to their final complementary surface through reactivation methods which include, but are not limited to bar sealing, and heated press rolling. A specific embodiment includes laminating multiple sheets of plastic, such as a polyolefin, to create a final mono-material composite film with functional layers, such as oxygen barriers or pigments, imbedded within. Such an embodiment is conducive to recycling as the reversible adhesive can delaminate the composite film in a water bath commonly utilized in recycling processes. These delaminated films can more easily be separated from contaminants than their delamination-resistant counterparts.

I claim:

1. A modified solvent system comprising:
a. an evaporable solvent,
b. betaine within 10-35% w/v, and
c. at least one monosaccharide totaling within 10-35% w/v;
wherein:
i. betaine and the monosaccharides synergistically facilitate the mutual dissolution into ethanol at significantly higher concentrations than the individual components; and
ii. betaine and the monosaccharides would alter the properties of the chosen evaporable solvent such that the solubility of hydrophilic compounds is improved into alcohol solvents if an alcohol was the solvent of choice; and
iii. the composition evaporates the evaporable solvent to leave a residue which has the potential to plasticize or dissolve collagen peptides with masses in the range of 1 to 30 kilodaltons.

2. A quorum solvent system and adhesive composition comprising:
a. the modified solvent system of claim 1 wherein the total monosaccharides and betaine are at concentration within 15-35% w/v individually; and
b. collagen peptides of molecular masses between 1 and 30 kilodaltons at a concentration greater than or equal to 1.0% w/v;
wherein:
i. the quorum solvent system has the potential to dissolve or stabilize proteinaceous and peptide components; and
ii. the quorum solvent system has the potential to evaporate the evaporable solvent to leave behind are residual film coating.

3. An adhesive composition comprising:
a. the quorum solvent system and adhesive of claim 2; and
b. less than 15% w/v of fillers and modifiers including but not limited to: gelatin, whey protein, cellulose particles, diatomaceous earth, clay particles, monosaccharide derivatives, disaccharides and their derivatives, oligosaccharides and their derivatives, and mineral carbonates.

4. A method for reversibly adhering at least two films together by:
a. applying an adhesive of claim 2 or 3 onto at least one surface of the films; and
b. fixing the films together through either heat reactivation, pressure activation, or combination thereof;
wherein the resulting composite film has the potential to be delaminated through heat or a water bath.

5. A method for reversibly adhering wooden or cellulosic materials together by:
a. applying an adhesive of claim 2 or 3 onto at least one surface; and
b. fixing the surfaces together through either evaporation, heat reactivation, pressure activation, or a combination thereof;
wherein the resulting fixed materials:
i. have the potential to be separated by heat or water; and
ii. have the potential to be cleaned with water.

6. A hot melt adhesive comprising the adhesives of claim 2 or 3 wherein:
a. the evaporable solvent is removed; and
b. the hot melt adhesive can be applied onto a surface during heating and solidify upon cooling to the temperature of its intended use.
